(19) United States
(12) Patent Application Publication
(10) Pub. No.: US 2015/0161922 A1
(43) Pub. Date: Jun. 11, 2015

(54) THREE-DIMENSIONAL IMAGE DISPLAY AND METHOD OF MAKING SAME

(71) Applicant: Stephan Szyman, Chicago, IL (US)

(72) Inventor: Stephan Szyman, Chicago, IL (US)

(21) Appl. No.: 14/102,051

(22) Filed: Dec. 10, 2013

(51) Int. Cl. G09F 23/00; B31D 5/00; G09F 1/08

(52) U.S. Cl. CPC G09F 23/00; G09F 1/08; B31D 5/0086

(57) ABSTRACT

A three-dimensional image display apparatus is formed from a set of pentagonal and hexagonal planar faces connected via a series of interfacing tabs that extend from the edges of the faces. One or more advertisements may be displayed on the external surface of the display, providing a unique, eye-catching advertising platform. Due to the fit between faces of the display, a two-dimensional advertisement may have gaps in its image when the panels are formed to make the apparatus. It therefore may be necessary to warp a two-dimensional image that spans multiple faces in order to yield a generally continuous image when the three-dimensional apparatus is formed.

### BACKGROUND OF THE INVENTION

The invention relates generally to advertising systems and more particularly to a marketing banner and a method of making the same.

Advertising systems, specifically billboards and signs, are used to display product or service advertisements to consumers. A traditional billboard or sign is a flat, two-dimensional display that requires consumers to be in front of the display to view the advertisement. If consumers are behind the display or off at an angle, viewing the advertisement on the display becomes difficult. If the advertising system is a small sign, displaying long words or a string of characters, such as a uniform resource locator (URL) or web address, is difficult to achieve without greatly reducing the font size on the display. If the font size is reduced, this limits the number of consumers who will see the display to only those in close proximity to the advertisement.

Additionally, advertising or marketing devices are designed to generate interest in the products or services they tout. As such, a display that resembles other, similar displays may attract less attention than desired or may not be as memorable as other displays.

What are needed are a display and a method of making the display that overcome one or more of these drawbacks.

### SUMMARY OF THE INVENTION

In one aspect, an image display apparatus may include a plurality of interconnected planar panels forming at least part of a three-dimensional dome and at least one advertisement displayed on at least one, and likely several, of the panels. Each panel may include a face having a plurality of edges and a plurality of tabs extending from the face at the edges, and each tab on a face is secured to a tab on an adjacent face. In addition, each face preferably is either a regular pentagon or a regular hexagon.

The image display apparatus also may include an equator bisecting at least three substantially identically shaped faces, and the advertisement may be displayed substantially parallel to the equator, e.g., as a generally continuous image. Portions of the generally continuous image may be modified to account for gaps in the image that result from translation of the advertisement from two dimensions to three dimensions.

In another aspect, an image display apparatus may include a geometric dome having a plurality of regular polygonal faces, each face having a tab extending from each edge at an angle, wherein each tab on one face interfaces with a tab on each adjacent face, the interfacing tabs being permanently secured together. A substantially straight surface edge is formed on an exterior surface of the geometric dome at each intersection of adjacent faces. In one embodiment, there may be 12 pentagonal faces and 20 hexagonal faces and, in another embodiment, there may be 12 pentagonal faces and 30 hexagonal faces.

The geometric dome may include an equator comprising a substantially straight line on each face, the equator bisecting at least three substantially identically shaped faces, wherein an image is displayed on multiple faces along the equator. In addition, at least one set of the interfacing tabs may be connected on the exterior of the geometrical dome. There also may be a hanging device attached to the geometrical dome and configured to suspend the geometrical dome from an attachment point.

In still another aspect, a method of making an image display apparatus may include the steps of: providing a two-dimensional surface on which an advertisement image is displayed, generating outlines of a plurality of panel blanks on the surface, where the blanks are positioned proximate adjoining blanks of an assembled image display apparatus and where each blank comprises a panel portion, a plurality of tab portions surrounding the panel portion, and a plurality of notches between the tab portions, removing the panel blanks from the surface, removing notches at the corners of the panel blanks, folding each tab portion to lie in a plane different than that of the panel portion, securing a tab portion on a first blank to a tab portion on a second, adjoining blank, and securing additional tab portions on adjacent blanks to form the assembled image display apparatus.

The method also may include the step of modifying the advertisement image to account for gaps in the image that result from translation of the advertisement from two dimensions to three dimensions. This modifying step may include positioning a blank between a plurality of adjacent blanks to generate a gap between a pair of blanks, and collapsing at least a portion of the gap onto either the blank or one of the plurality of adjacent blanks.

The collapsing step may include the sub-steps of dividing the image on the blank or one of the plurality of adjacent blanks into a plurality of pixels, dividing the image in the gap into a second plurality of pixels, removing a portion of the pixels proximate the gap, and replacing the removed pixels with pixels selecting from the second plurality of pixels. Additionally or alternatively, the collapsing step may include the sub-steps of determining a central point on the blank or one of the plurality of adjacent blanks, dividing the image on the blank or one of the plurality of blanks into a plurality of pixels, dividing the image in the gap into a second plurality of pixels, extending a plurality of rays outward from the central point, removing, along each ray, a number of pixels on the blank or one of the plurality of blanks in proportion to a number of pixels in the gap, compressing, along each ray, non-removed pixels inward towards the central point, and replacing, along each ray, pixels between the non-removed pixels and an edge of the panel portion with pixels from the gap.

These and other features and advantages are evident from the following description of the present invention, with reference to the accompanying drawings.

### BRIEF DESCRIPTION OF THE DRAWINGS

FIG. 1 is a side view of one embodiment of a three-dimensional image display.

FIG. 2 is a side view of a second embodiment of a three-dimensional image display.

FIG. 3 is a perspective view of a partial assembly of the display of FIG. 1.

FIGS. 4A-4B are side views of templates used to form hexagonal and pentagonal faces, respectively, of the image displays of FIGS. 1 and 2.

FIGS. 5A-5B are side views of the templates of FIGS. 4A and 4B, respectively, with notches removed to form tabs.

FIGS. 6A-6B are side views of templates of FIGS. 5A and 5B, respectively, with the tabs folded for securement to other template pieces.

FIG. 7 is a top view illustrating the division of a two-dimensional representation of an image, where the displayed irregular polygons are shown prior to transformation.

FIG. 8 is a top view of one way to arrange the regular polygons of FIG. 7 on a planar surface.

FIG. 9 is a top view of the polygons of FIG. 8, illustrating one method by which the portions of an image located between polygons would be collapsed onto the polygons for image continuity.

FIG. 10 is a top view of one polygon and the gap surrounding it, illustrating one method by which the gap can be subdivided into smaller units.

FIG. 11 is a top view of the polygon and gap of FIG. 10, illustrating one pixel elimination method.

FIG. 12 is a top view of the polygon and gap of FIG. 10, illustrating one example of a pixel replacement method.

### DETAILED DESCRIPTION

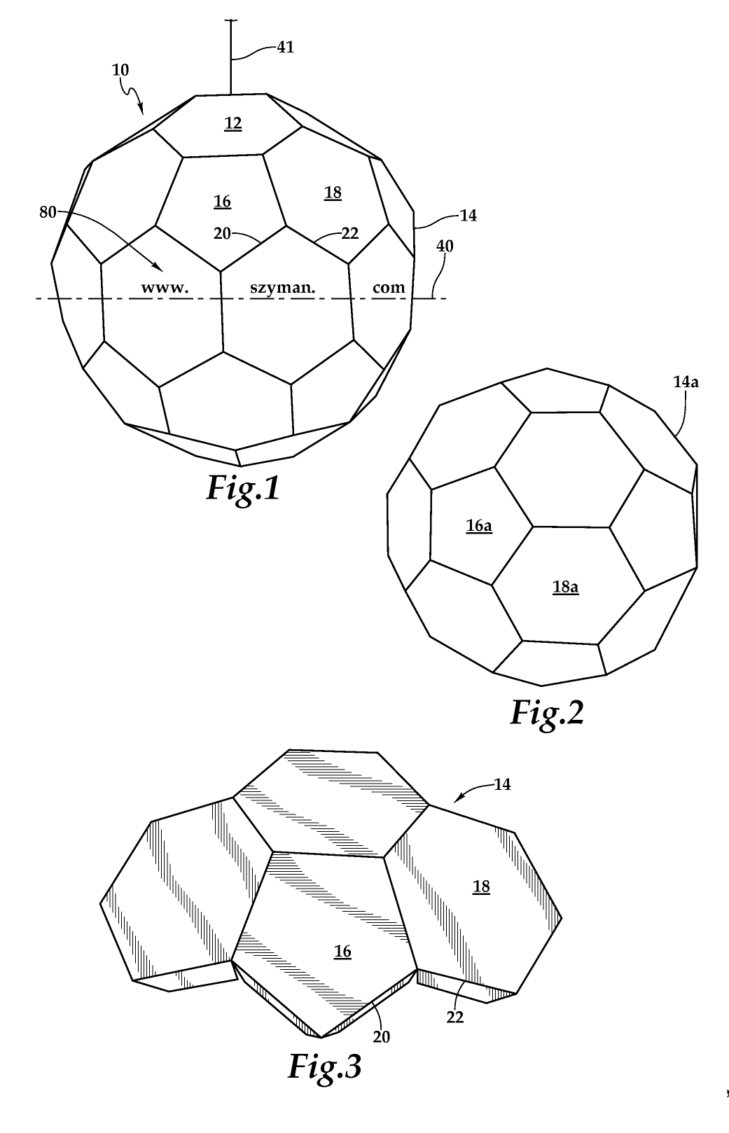

In one aspect, a three-dimensional image display 10 comprises a geometrical dome including regular polygonal faces or panels 12 coupled together to form surface of geometrical dome 14. Geometrical dome 14 may be a polyhedron formed from polygonal faces that create an exterior surface. Polygonal faces preferably are not all the same throughout dome 14, which may provide dome 14 with a distinct shape. In the embodiment shown in FIG. 1, polygonal faces comprise twelve regular pentagonal faces 16 and thirty regular hexagonal faces 18. In the embodiment shown in FIG. 2 and described in greater detail below, dome 14a may comprise twelve pentagonal faces 16a and twenty hexagonal faces 18a.

In either embodiment, polygonal faces can be any size, but a length of the edges 20 of pentagonal faces 16 preferably is equal to a length of the edges 22 of hexagonal faces 18. As such, hexagonal faces may be disposed along each pentagonal face comprising dome 14, in a manner such as that seen in FIG. 3.

Polygonal faces preferably may be made from recycled cardstock, but it is contemplated that polygonal faces can be made from other materials. Preferably, the material used to make faces is light and flexible, yet still able to retain its shape. Other exemplary materials may include paper, cardboard, aluminum, or the like.

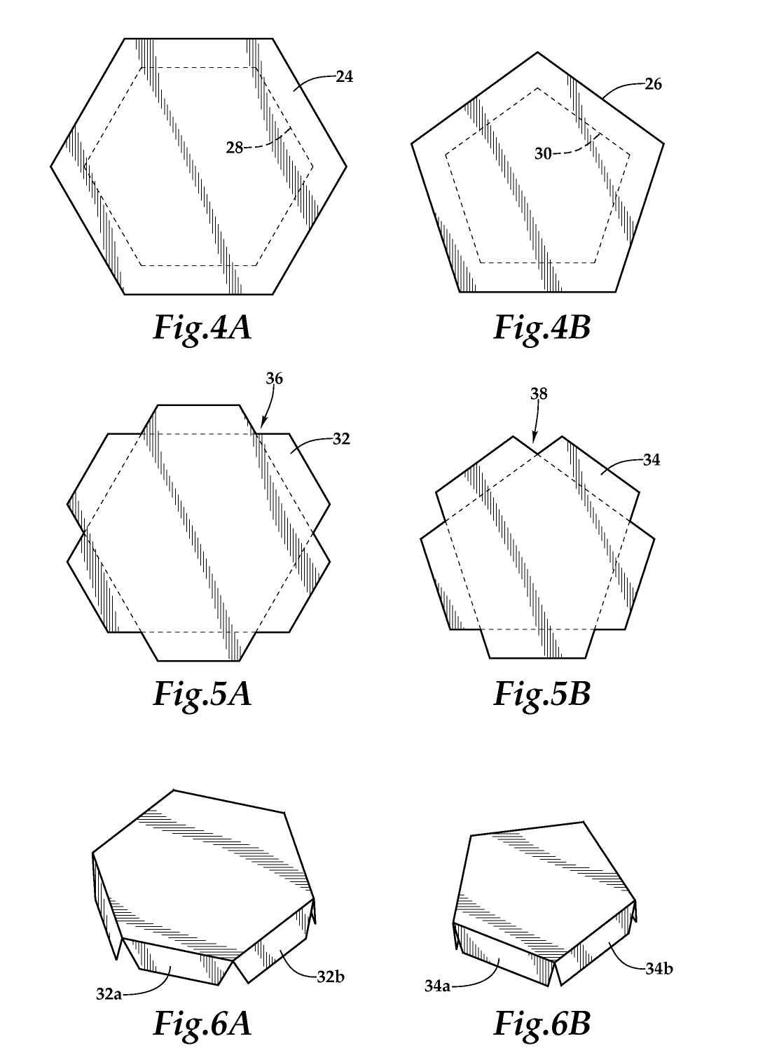

Referring now to FIGS. 4-6, one manner of the assembly of image display 10 may be shown and described. This display may be assembled by hand, although automated assembly methods also are acceptable.

Hexagonal and pentagonal faces may be prepared according to similar methods, as discussed below. FIGS. 4A-6A show a preparation process for hexagonal faces, while FIGS. 4B-6B show the same preparation process for the pentagonal faces.

The preparation process may be similar for both types of polygonal faces. First, a plurality of hexagonal and pentagonal blanks 24, 26 such as those shown in FIGS. 4A and 4B may be formed, e.g., by cutting blanks 24, 26 from a larger piece of material. Dashed lines 28, 30 on each blank may represent a final size for exterior surfaces of faces, i.e., they may be generally coincident with edges 20, 22, respectively.

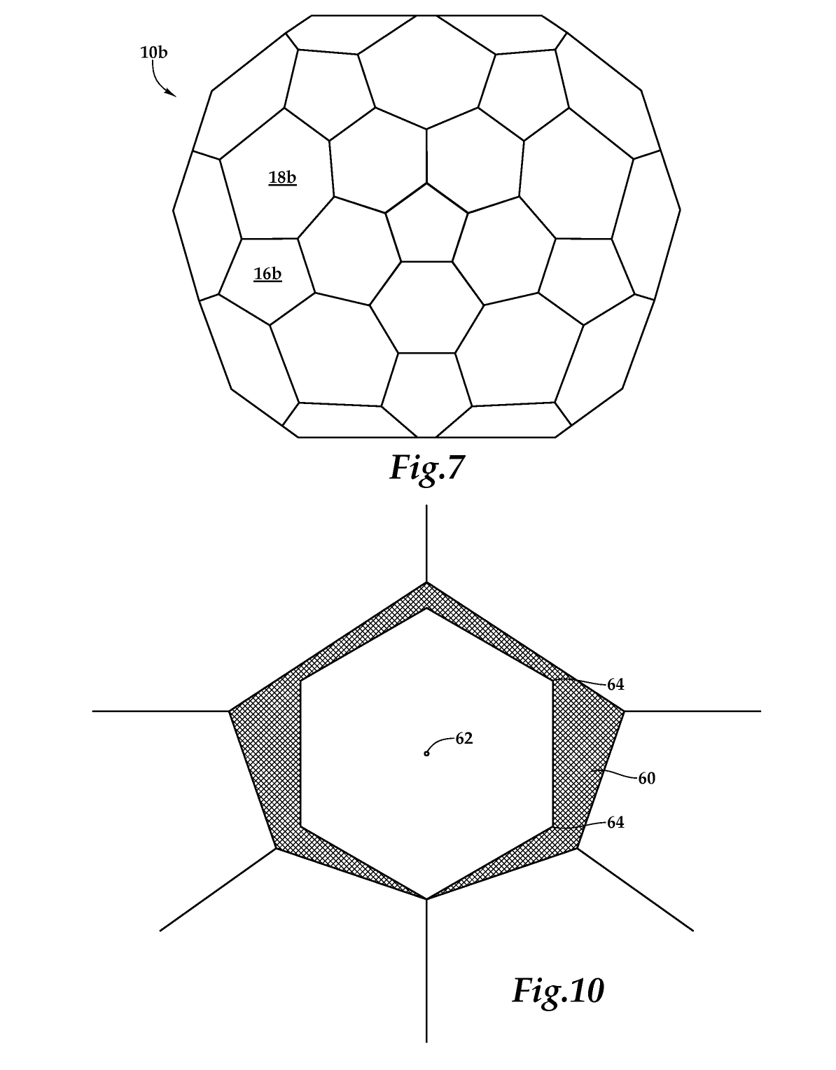

The area between external edges of blanks and dashed lines may be used to form a plurality of tabs 32, 34. In particular, material may be removed at each vertex to form a plurality of notches 36, 38, as seen in FIGS. 5A and 5B. Notches have an angular extent between adjacent tabs of at least 90 degrees and, preferably, more than 90 degrees, which allows one tab 32a, 34a to be folded along dashed line 28, 30 without contacting or interfering with an adjacent tab 32b, 34b, as seen in FIGS. 6A and 6B. In addition, each notch preferably is symmetrical about a line including vertices of blanks and dashed lines.

In one embodiment, tabs preferably are folded or otherwise bent to an angle that is substantially normal to polygonal face. In another embodiment, a first tab may be folded at an acute or obtuse angle relative to a first face, provided that the second tab to which it couples on an adjacent face is bent preferably an amount equal to the difference between the desired angle between the faces and the angle formed by the first face and tab.

Returning now to FIG. 3, the faces may be assembled together with each tab of a pentagonal face interfacing with a tab of a hexagonal face. Interfacing tabs sharing the same edge are connected or affixed together.

Each tab extending from a pentagonal face interfaces with a tab extending from a hexagonal face, although each tab extending from a hexagonal face may interface with a tab extending from either a pentagonal face or a hexagonal face.

Pentagonal and hexagonal faces may be connected together one-by-one until all tabs on all faces are connected to form part, or preferably all, of geometrical dome 14.

Interfacing tabs may connect either on the exterior or the interior of geometrical dome. It is preferable, however, that a majority, if not all, of tabs from both the hexagonal and the pentagonal faces are connected on the inside of the geometrical dome, which may result in a smoother, more continuous, and potentially more aesthetically pleasing exterior surface.

When assembling the last polygonal face of geometrical dome, it may be necessary to connect the tabs of at least one edge on the exterior of geometrical dome. The one or more tabs connected on the exterior of geometric dome may be trimmed down after connecting to reduce the length of tab extending from dome.

Additionally or alternatively, a face with exterior tab connections may be oriented or disposed in a location so as to minimize visibility of exterior tabs. For example, if display 10 is to be suspended from the ceiling such that viewers will see the sides and underside of display, face with exterior connections may be disposed proximate an upper end of display. Alternatively, display may be placed on a base that obscures a portion of display 10. In that case, face with exterior connections may be disposed proximate a bottom end of display. In still another alternative, display 10 may be placed in front of a wall or similar surface, creating and obscuring a “back” side of display. In that case, face with exterior connections may be disposed along the back side.

Tabs may be connected together by stapling, fastening, gluing, taping, adhering, sonic welding, or by any other like means.

Referring again to FIG. 1, in an embodiment, display 10 may include an equator 40 that extends around the display in a generally straight line. Equator 40 may be defined by and may pass through a plurality of hexagonal faces lying in a common plane and having substantially identical orientation extending around geometrical dome.

One or more images, advertisements, or other pieces of content may be displayed on exterior surface of geometrical dome 14. A continuous advertisement 80 may be depicted along the equator such that the advertisement may span a plurality of panels, preferably hexagonal panels. The equator may be used to display images or a broad sequence of characters in a generally straight line, i.e., putting one image in a sequence of images on each hexagon portion. Long strings of characters, such as a URL or web address may be displayed along the equator, as seen, e.g., in FIG. 1.

In one aspect, content displayed on each face 16, 18 may be independent from or distinct in comparison to other faces on dome 14, although the same image could be on more than one face and still be considered “distinct.” In another aspect, content may span multiple faces, preferably multiple contiguous faces, such that a portion of the content may be printed or otherwise displayed onto each individual polygonal face. In another embodiment, the same sequence or same image may be repeated on opposite sides of display 10, e.g., along the equator, so a consumer can see the same advertisement from both sides of the display. In each of these examples, display 10 may be weighted, with weight preferably disposed proximate a bottom panel, more preferably disposed proximate an interior surface of bottom panel.

Referring again to FIG. 2, another embodiment of an image display 10a is a geometrical dome having a truncated icosahedron or “buckyball” shape. In this embodiment, dome 12a may include twelve pentagonal faces 16a and twenty hexagonal faces 18a. Each pentagonal face is connected on each of its edges 20a to a hexagonal face on a respective edge 22a, while edges 22a of each hexagonal face are connected or disposed adjacent either to a pentagonal face or other hexagonal faces.

Display 10a may be assembled and utilized in a manner similar to the methods of assembly and use described above for display 10, although display 10a may not include an equator similar to equator 40.

In other embodiments (not shown), a number of hexagonal faces can be increased while keeping the number of pentagonal faces at twelve. As the number of hexagonal faces increases, the pentagonal faces still may be connected to hexagonal faces on each of their edges. Additionally, certain hexagonal faces will be connected to both pentagonal faces and hexagonal faces, while other hexagonal faces may be connected only to other hexagonal faces.

In one embodiment, display 10 may include a hanging device 41 extending from a face, from an edge between two faces, or from a vertex joining three faces. Hanging device 41 may affix to an attachment point such as a rafter or the ceiling, such that it may suspend display 10 above the ground. Hanging device may comprise a string, a hook, or any other device capable of securing marketing banner to an attachment point.

As discussed previously, a weight may be put inside geometrical dome during assembly to enable marketing banner to hang straight and to prevent excessive movement caused by wind or airflow while in use. In another embodiment, display 10 may be free to rotate, thereby displaying all polygonal faces of geometrical dome.

The geometrical dome shape of display 10 enables a consumer to view an advertisement depicted on exterior surface of dome from multiple sides or angles, thereby increasing visibility over standard polyhedron surfaces such as pyramids and cubes or other boxes. Simultaneously, the multi-surfaced character of display 10 may permit multiple distinct images to be shown on display more easily than on a continuous surface such as a sphere or hemisphere.

Because each face of display 10 preferably is substantially planar, it may be desirable to extract each face from a single substrate, although there may be issues if the image to be shown is to span multiple faces, as discussed below.

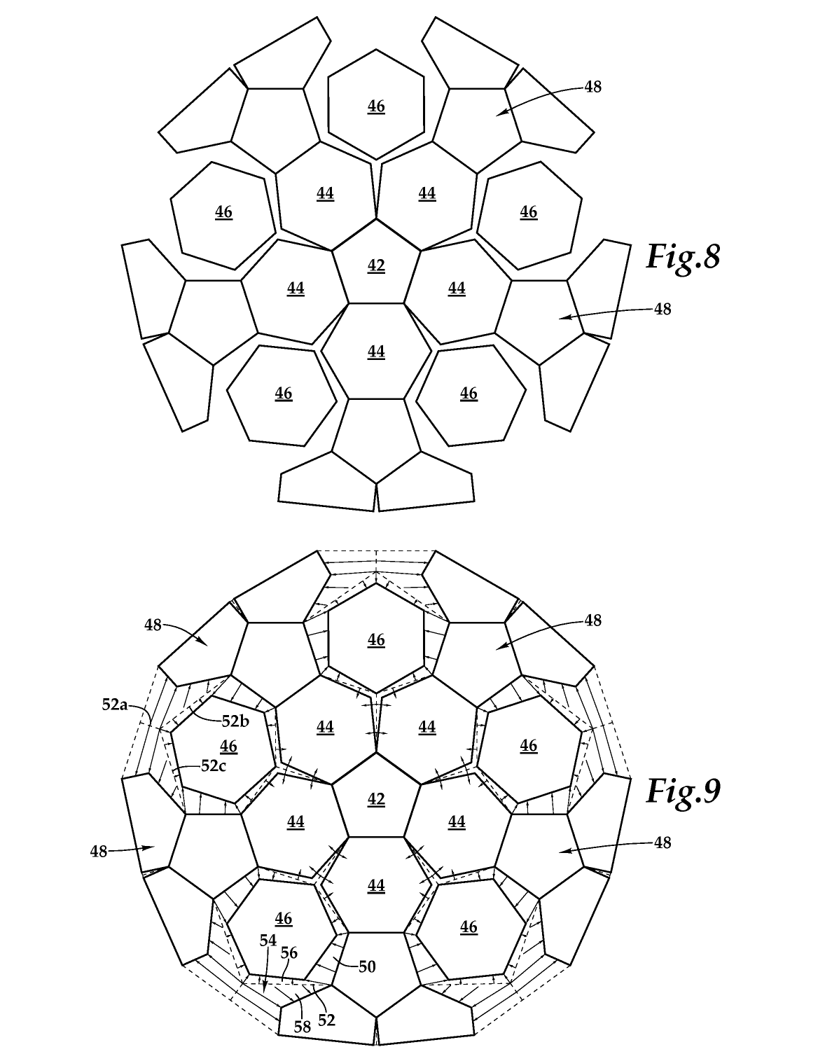

FIG. 7 illustrates a two-dimensional representation of a portion of another embodiment of display 10b. This portion of the display includes six pentagonal surfaces 16b and twenty hexagonal surfaces 18b. As can be seen in the figure, translating from three-dimensions into a two-dimensional image means that the surfaces appear to be irregular polygons. However, as also can be seen, there are no gaps between edges of the polygons, i.e., a two-dimensional image would be continuous if the panels were extracted in this fashion.

Turning now to FIG. 8, it is seen that the regular polygons that actually are used to form display faces may abut along certain edges but also may result in gaps between the surfaces on the substrate. If the polygons were extracted from this single surface in this way, there would be discontinuities in the display image, resulting in gaps or “lost” portions of the image when translated to display 10.

As such, the irregular polygons need to be “collapsed” or “drawn in” to the regular surfaces, and any image that would have filled the irregular polygonal surfaces similarly is warped or collapsed onto the regular surfaces. One example of a collapsing methodology is shown in FIG. 9, where the arrows represent a direction in which the gap image is collapsed.

As will be appreciated from inspection and comparison of FIGS. 8 and 9, a first step in the methodology may be abutting faces wherever possible so as to provide image continuity. This step may involve selecting a central face 42, which preferably is one of the pentagonal faces, abutting the faces 44 that directly contact the edges of the central face, and then continuing to abut faces that extend outward in a generally radial direction. The result of this step may be the connection of a majority of the faces together, with one or more floating faces 46 disposed between branches 48 of abutting faces.

In one embodiment, a floating face 46 may be oriented so as to abut an edge of a face on one of branches 48. While providing for direct contact and, therefore, direct continuity of the image on the “floating” face with the abutting face, this method may yield a large gap opposite the abutting edge. Instead, and as seen in FIG. 8, it may be preferable to locate floating face 46 between and spaced from adjacent branches 48, more preferably substantially equally spaced between branches 48. In this way, while it may be necessary to collapse gaps on both sides of floating face 46, a final image produced according to this embodiment may appear more natural and continuous across multiple faces than an image where floating face abuts branch 48, since less collapsing is necessary for the smaller gaps.

In one aspect, the entire portion of the gap image between two faces may be collapsed onto a single face, as shown by a region 50 in FIG. 9 in which arrows point only in a single direction between the edges of two faces. In another aspect, there may be at least one divide 52 between regions in a gap, creating a multidirectional gap region 54 in which a first region 56 is collapsed onto a first face and a second region 58 is collapsed onto a second face. Divide 52 may be created, e.g., by drawing a line from an intersection of two or more vertices on branch 48 to a vertex on floating face 46.

In the event of a large gap, such as around the perimeter, it may be desirable to generate more than one divide. For example, a first divide 52a may extend radially outward from a vertex of floating face 46, and second and third divides 52b, 52c may extend from an intersection of vertices along branch 48 to an intersection with first divide 52a. Preferably, second and third divide 52b, 52c intersect each other at the same location along first divide 52a.

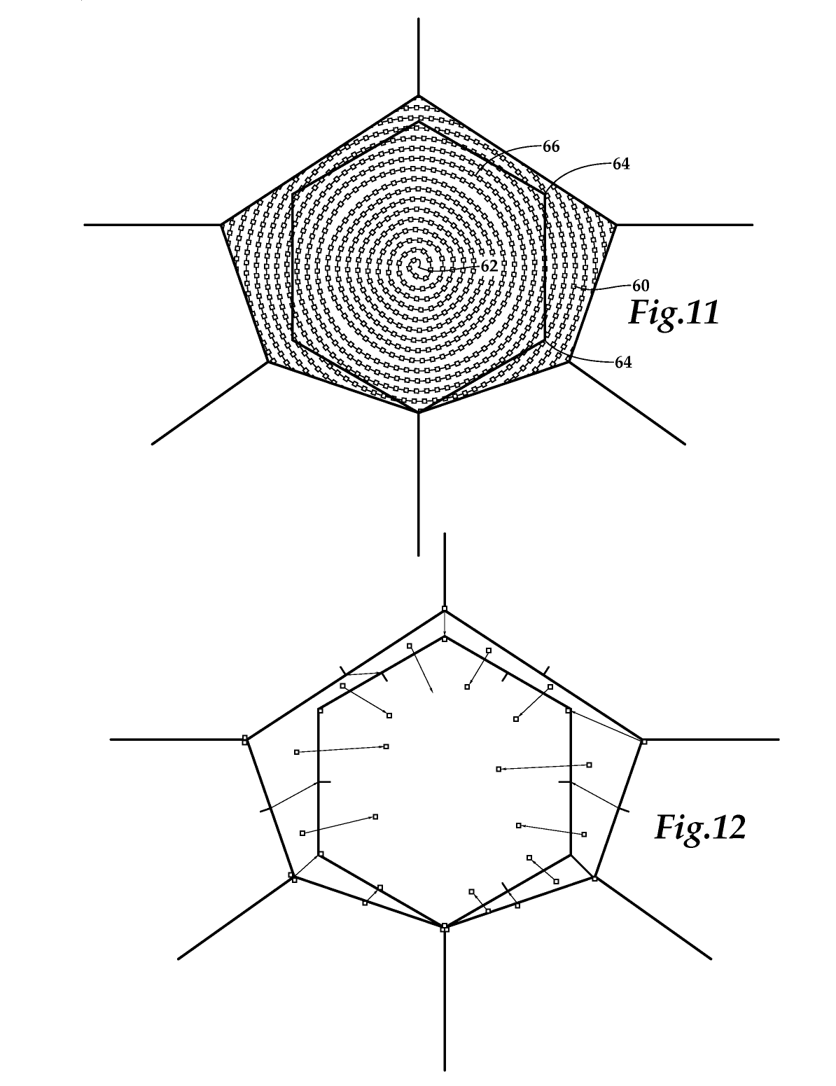

Turning now to FIG. 10, a depiction of the gap region surrounding the sides of a hexagonal face is shown. Gap region may be subdivided into a plurality of pixels, or a mesh surface may be overlaid with gap region to subdivide the region into a plurality of distinct image units. For the sake of simplicity, both pixels and distinct image units may be referred to as “pixels” 60.

At the same time, a pixel removing algorithm may be applied to each face that is to receive pixels from a gap region, i.e., to every face except for central face 42. One such algorithm may comprise determining a central point 62 of the face and dividing the face into a series of segments defined by the rays extending from central point 62 to the vertices 64 of the face and determining the number of pixels in the gap region adjacent a segment are to be compressed into that segment. Turning to FIG. 11, the method also may include generating a spiral 66 expanding outward from the central point 62, and removing a number of pixels in the portion of spiral 66 that falls within a segment that is equal or approximately equal to the number of pixels to be compressed.

Pixels along spiral may be removed in proportion to a number of pixels that are to be added, although that comparison may occur along or proximate a ray extending outward from central point 62 of face to account for the fact that the compression region, e.g., region 50, 54, 56 (see FIG. 9), may contribute more pixels along one portion of an edge than along another because the region does not have a uniform thickness relative to the edge.

Once pixels within face are removed, remaining pixels may be compressed radially inwardly, leaving a blank region internal to an edge of the face. Pixels from gap region 50, 54, 56 then may be moved inwardly toward central point 62, thereby filling the blank region.

In one aspect, an equal number of pixels in a gap region along a ray may be compressed or otherwise added in to the face. Preferably, however, a proportion of pixels that are added from the gap region may be substantially equal to the proportion of pixels removed along a ray within the face so that the added pixels do not dominate the image on the face and further contribute to a warped appearance.

Once the image has been compressed inwards to account for portions of image in gap section between face templates, a second image compression (not shown) may occur. As will be remembered from the discussion above and from FIGS. 4A-6B, each panel blank 24, 26 includes both the panel face and a plurality of tabs 32, 34 surrounding the face (with notches 36, 38 between the tabs that ultimately are removed). Panel face and panel blank may have substantially the same shape, e.g., both may be regular pentagons or hexagons. As such, the second image compression may comprise a simple scaling to shrink the image from the blank size to the size of the face, yielding a blank perimeter that ultimately will form tabs 32, 34 and notches 36, 38.

The image compression method described above is one way in which an image may be compressed when forming panel pieces from a single substrate that contains a continuous image. Other compression methods are possible and may be considered within the scope of the invention.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The claims should therefore not be limited by the above described embodiment and method, but by all embodiments and methods within the scope and spirit of the invention as claimed.

What is claimed is:

1. An image display apparatus, comprising:
a plurality of interconnected planar panels forming at least part of a three-dimensional dome; and
at least one advertisement displayed on at least one of the panels;
wherein each panel comprises a face having a plurality of edges and a plurality of tabs extending from the face at the edges;
wherein each tab on a face is secured to a tab on an adjacent face; and
wherein each face is either a regular pentagon or a regular hexagon.

2. The image display apparatus of claim 1, wherein the advertisement extends across a plurality of faces.

3. The image display apparatus of claim 2, further comprising:
an equator bisecting at least three substantially identically shaped faces, wherein the advertisement is displayed substantially parallel to the equator.

4. The image display apparatus of claim 2, wherein the advertisement is a generally continuous image.

5. The image display apparatus of claim 4, wherein portions of the generally continuous image are modified to account for gaps in the image that result from translation of the advertisement from two dimensions to three dimensions.

6. A method of making an image display apparatus, comprising:
providing a two-dimensional surface on which an advertisement image is displayed;
generating outlines of a plurality of panel blanks on the surface,
wherein the blanks are positioned proximate adjoining blanks of an assembled image display apparatus;
wherein each blank comprises a panel portion, a plurality of tab portions surrounding the panel portion, and a plurality of notches between the tab portions;
removing the panel blanks from the surface;
removing notches at the corners of the panel blanks;
folding each tab portion to lie in a plane different than that of the panel portion;
securing a tab portion on a first blank to a tab portion on a second, adjoining blank; and
securing additional tab portions on adjacent blanks to form the assembled image display apparatus.

7. The method of making the image display apparatus of claim 6, further comprising:
modifying the advertisement image to account for gaps in the image that result from translation of the advertisement from two dimensions to three dimensions.

8. The method of making the image display apparatus of claim 7, wherein the modifying step includes:
positioning a blank between a plurality of adjacent blanks to generate a gap between a pair of blanks; and
collapsing at least a portion of the gap onto either the blank or one of the plurality of adjacent blanks.

9. The method of making the image display apparatus of claim 8, wherein the collapsing step includes:
dividing the image on the blank or one of the plurality of adjacent blanks into a plurality of pixels;
dividing the image in the gap into a second plurality of pixels;
removing a portion of the pixels proximate the gap; and
replacing the removed pixels with pixels selected from the second plurality of pixels.

10. The method of making the image display apparatus of claim 8, wherein the collapsing step includes:
determining a central point on the blank or one of the plurality of adjacent blanks;
dividing the image on the blank or one of the plurality of blanks into a plurality of pixels;
dividing the image in the gap into a second plurality of pixels;
extending a plurality of rays outward from the central point;
removing, along each ray, a number of pixels on the blank or one of the plurality of blanks in proportion to a number of pixels in the gap; and
compressing, along each ray, non-removed pixels inward towards the central point; and
replacing, along each ray, pixels between the non-removed pixels and an edge of the panel portion with pixels from the gap.

11. An image display apparatus, comprising:
a geometric dome including a plurality of regular polygonal faces, each face having a tab extending from each edge at an angle, wherein each tab on one face interfaces with a tab on each adjacent face, the interfacing tabs being permanently secured together;
wherein a substantially straight surface edge is formed on an exterior surface of the geometric dome at each intersection of adjacent faces.

12. The image display apparatus of claim 11, wherein the plurality of faces comprises 12 pentagonal faces and 20 hexagonal faces.

13. The image display apparatus of claim 11, wherein the plurality of faces comprises 12 pentagonal faces and 30 hexagonal faces.

14. The image display apparatus of claim 13, wherein the geometric dome includes an equator comprising a substantially straight line on each face, the equator bisecting at least three substantially identically shaped faces, wherein an image is displayed on multiple faces along the equator.

15. The image display apparatus of claim 11, wherein at least one set of the interfacing tabs is connected on the exterior of the geometrical dome.

16. The image display apparatus of claim 11, further comprising a hanging device attached to the geometrical dome and configured to suspend the geometrical dome from an attachment point.
